(19) United States
(12) Patent Application Publication
(10) Pub. No.: US 2002/0030989 A1
(43) Pub. Date: Mar. 14, 2002

(54) Portable light board

(76) Inventor: Levin K. Stephen, Far Hills, NJ (US)

Correspondence Address: DARBY & DARBY, 805 THIRD AVENUE, 27TH FLR., NEW YORK, NY, 10022, US

(21) Appl. No.: 09/863,890

(22) Filed: May 23, 2001

Related U.S. Application Data
(60) Provisional application No. 60/206,581, filed on May 23, 2000.

(51) Int. Cl. A47B 19/10; F21V 9/16

(52) U.S. Cl. 362/98; 362/84; 362/99; 362/253

(57) ABSTRACT

A light board includes a clip assembly, an electro-luminescent panel, a power supply, a power switch, and an operating circuit. A worksheet of transparent material may be placed against the light board, and optionally secured to the board using the clip assembly. Once the worksheet is positioned against the light board, the EL panel may be turned on by supplying power from the power supply through the switch to the operating circuit, which in turn, causes the EL panel to emit light behind the adjacent worksheet. The light board provides even, efficient light which is useful in viewing any planar transparent sheet of material, such as photographic and radiographic transparencies, graphic art work, and maps and charts.

### RELATED PATENT APPLICATIONS

This patent application claims priority from US provisional patent application, serial no. 60/206,581, filed May 23, 2000, entitled: Portable Light Board, whose entire content is hereby incorporated by reference.

### BACKGROUND OF THE INVENTION

1. Field of the Invention

The present invention generally relates to portable illumination devices, and in particular, light boards having a clip assembly.

2. Description of the Prior Art

Medical X-ray films (radiographic imaging film) usually are examined by placing them on the viewing screen of a device commonly referred to as an illuminator or X-ray viewer. Such devices contain one or more fluorescent tubes or other sources of light, and have a front panel typically comprising a translucent light diffuser, such as a sheet of milky white Plexiglas. Each radiographic imaging film is placed on the light diffuser and back-illuminated for viewing. The light passing through the diffuser is scattered and is thereby more evenly distributed across the imaging film so that the film mounted to the viewer is uniformly illuminated.

These illumination boxes are large, heavy structures which are typically mounted to a wall within a viewing room of a hospital or clinic. The fluorescent illumination sources require a standard 120 volt connection and the boxes themselves are not portable.

There is a need for a portable illuminator for providing back illumination to sheet transparencies and film. The portable device should be light weight, durable, relatively inexpensive, and easy to use. The portable device should also be powered with batteries and therefore requires an efficient source of illumination. The illumination source should be lightweight, low profile, and safe to handle.

### SUMMARY OF THE INVENTION

A light board includes a clip assembly, an electro-luminescent panel, a power supply, a power switch, and an operating circuit. A worksheet of transparent material may be placed against the light board, and optionally secured to the board using the clip assembly. Once the worksheet is positioned against the light board, the EL panel may be turned on by supplying power from the power supply through the switch to the operating circuit, which in turn, causes the EL panel to emit light behind the adjacent worksheet.

The light board provides even, efficient light which is useful in viewing any planar transparent sheet of material, such as photographic and radiographic transparencies, graphic art work, and maps and charts.

### BRIEF DESCRIPTION OF THE DRAWINGS

FIG. 1 is a perspective view of a light board having a front surface, a clip assembly, and an electro-luminescent panel mounted to the front surface, according to the invention;

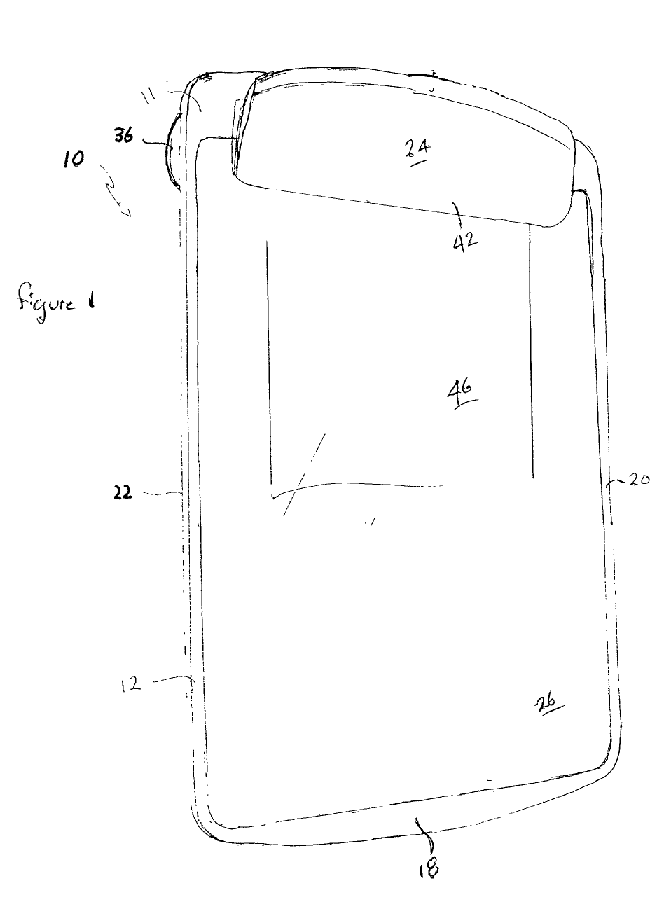

FIG. 2 is a side view showing the front surface, the electro-luminescent panel, a battery compartment, a power switch, and the clip assembly, according to the invention; and

FIG. 3 is a basic electrical schematic showing the electro-luminescent panel, the power switch, batteries, and an operating circuit, according to the invention; and

FIG. 4a-4c are perspective views of the present light board showing the light board turned off (FIG. 4a), turned on (FIG. 4b), and turned on and supporting a worksheet (FIG. 4c).

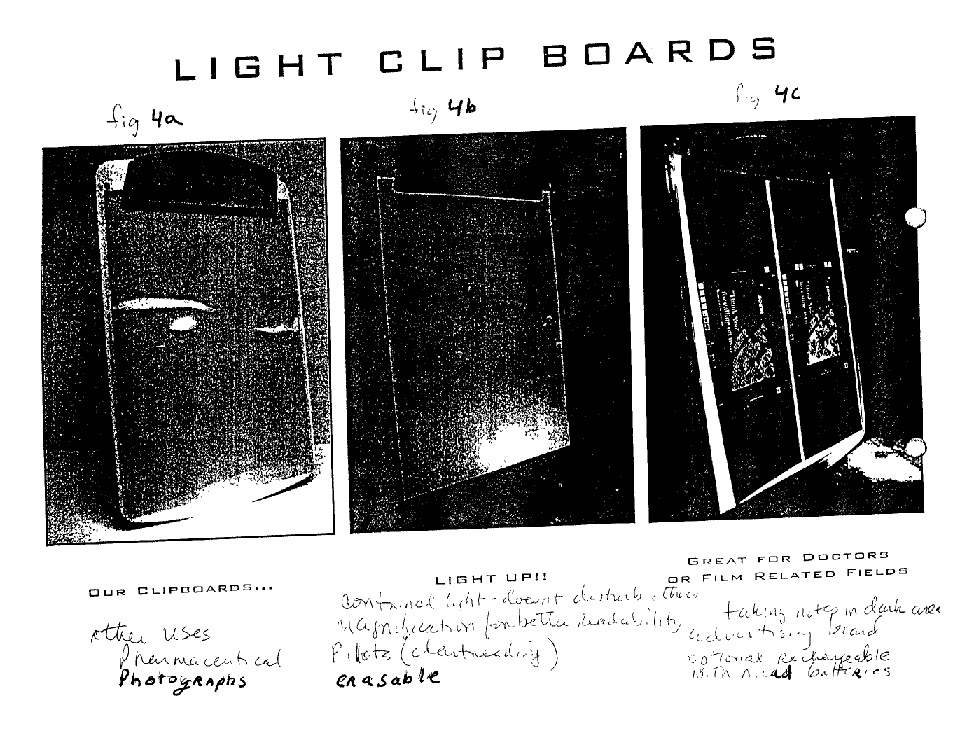

### DETAILED DESCRIPTION OF THE INVENTION

The purpose of this invention is to provide a convenient, lightweight, portable light source for supplying evenly distributed back lighting to various transparent and translucent planar worksheets (a worksheet is any planar transparent or translucent material and may include an X-ray transparency, a photographic transparency, a negative, a slide, or paper documents, such as maps and charts).

Referring to the figures, a light board 10, according to the invention, is shown having a support panel 11, an electro-luminscent panel 26, and a clip assembly 24. The support panel 11 is preferably rigid or semi-rigid and includes a flat front surface 12, a rear surface 14, a top edge 16, a bottom edge 18, two parallel side edges 20, 22. The electro-luminescent panel (EL panel ) 26 and the clip assembly 24 are both attached to the front surface 12 of the support panel 11.

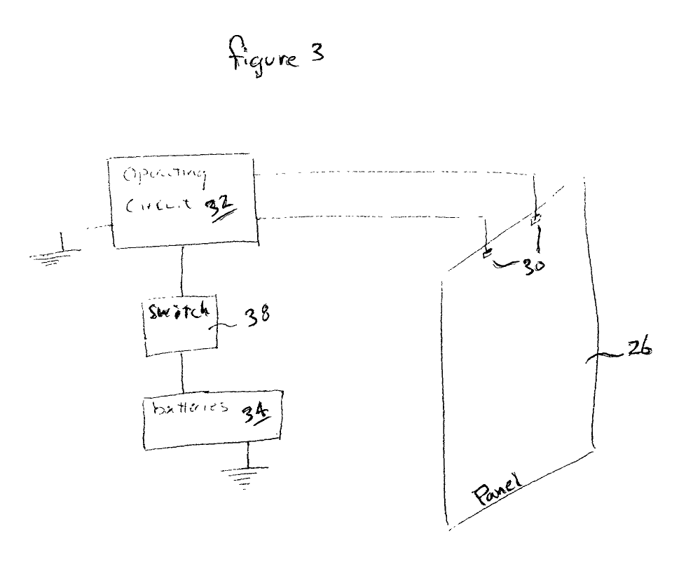

The EL panel 26 is preferably laminated to the front surface of the support panel 11 using an appropriate adhesive or may alternately thermally fused, as is well known. The EL panel 26 includes an upper end 28 which is preferably positioned between the clip assembly 24 and the front surface 12 of the support panel 11. As shown in FIG. 3, electrical contacts 30, which are used to supply power to the EL panel 26, are connected to an appropriate operating circuit 32 and a power supply 34. The EL panel 26 is commercially available and is typically encased within a laminate structure so that the high-voltage and delicate phosphorous layer is isolated from the outside environment. It is contemplated that the protective plastic laminate of the EL panel 26 may be used as a writing surface wherein a dry-ink type pen may be used to write indicia onto the EL panel. The writing may be easily erased using a cloth.

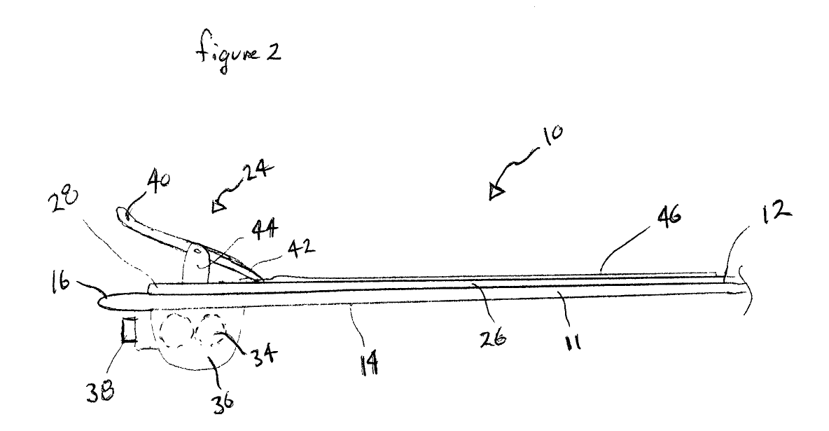

The operating circuit 32 which may be conventional and is well known in the art, is used to step up its input voltage to approximately 120 volts and further controls the output frequency of the stepped up voltage to a value between 600 hz and 3000 hz. The power supply 34 is preferably in the form of batteries (shown in phantom in FIG. 2) which are housed within a battery compartment 36. Power supplied from the batteries to the operating circuit is controlled by an appropriate electrical switch 38, which is mounted to a portion of the support panel 11 and/or the battery compartment 32.

As shown in FIG. 2, the battery compartment 36 is preferably attached to the rear surface 14 of light board 10 adjacent to the top edge 16. Alternately, the battery compartment may be formed integrally with the support panel 11. The battery compartment 36 is preferably located at one edge of the support panel 11 to form a convenient grip or handle, while also functioning as a stand to tilt the support panel 11 when the light board 10 is placed on a desktop.

The clip assembly 24 may be conventional and generally includes a handle portion 40, a gripping portion 42, a fulcrum 44, and a spring (not shown). As is well known, the clip assembly 24 is attached adjacent to the top edge 18 of the support panel 11 so that the gripping portion 42 is spring biased into contact with the front surface 12, creating a clamping action which may be used to hold a planar article against the front surface 12 of the support panel 11. A user may selectively separate the gripping portion 42 from the front surface 12 by depressing the opposing handle portion 40 about the fulcrum 44 against the action of the spring (not shown).

In use, a work sheet 46 is positioned against the front surface 12 of the support panel of the light board 10. A portion of the worksheet 46 may be secured to the front surface 12 of the support panel 11 by using the clip assembly 24, as described above, however use of the clip assembly 24 is optional. Once positioned against the front surface 12, the worksheet 46 may be selectively back lit by turning on the EL panel 26. Power from batteries 34 may be supplied to the operating circuit 32 by actuating switch 38 (either on or off). Once on, the EL panel 26 will emit an even and relatively bright source of light which covers the entire area of the EL panel 26, effectively lighting the entire front surface 12 of the light board 10, and thereby providing back light to any transparent or translucent worksheet 46 located against front surface 12.

The operating circuit 32 preferably includes controls for selectively varying the intensity and the “temperature” of the output light (the “temperature” of the output light may be controlled by varying the frequency of the power supplied to the EL panel 26).

The resulting light board 10 is lightweight, easy to use, and portable, and provides a uniform illumination and small size that replaces the prior art flourescent bulb-type illuminators. The present light board may be used in any environment where planar transparencies are viewed. The emitted light is efficiently and evenly distributed and is sufficiently bright to effectively back light the held worksheet.

What is claimed is:

1. An illuminating clip-board comprising:
a generally flat board having a front surface and an upper end;
a planar light source made from an electro-luminescent material, said light source being laminated to said upper surface of said flat board;
a clip assembly secured to said upper end of said flat board, said clip assembly including a pivotal clip having a contact edge, said clip being pivotal between a closed position wherein said contact edge is in tight abutment with said upper surface of said flat board, and an open position wherein said contact edge is positioned away from said upper surface of said flat board;
a battery for providing power to said light source;
controlling circuitry for controlling the operation of said light source; and
a battery housing for containing said battery and said controlling circuitry, said battery housing being attached to said flat board.

2. The illuminated clip-board, according to claim 1, wherein said flat board includes a rear surface and said battery housing is attached to said rear surface.

3. The illuminated clip-board, according to claim 2, wherein battery housing is attached to said rear surface of said flat board at said upper end, opposite said clip assembly.

4. The illuminated clip-board, according to claim 1, wherein said planar light source is bonded to said upper surface of said flat board.

5. The illuminated clip-board, according to claim 1, wherein said planar light source is coated with a transparent protective layer of plastic.

6. The illuminated clip-board, according to claim 5, wherein said protective layer includes an exposed surface that is suitable for supporting ink from a writing implement.

7. The illuminated clip-board, according to claim 1, wherein said board is made from a transparent plastic material.

8. The illuminated clip-board, according to claim 1, wherein said controlling circuitry includes an electrical switch for controlling the operation of said light source.

9. An illuminating clip-board comprising:
a generally flat board having a front surface, a rear surface, and an upper end;
a planar light source made from an electro-luminescent material, said light source being attached to said upper surface of said flat board;
a battery for providing power to said light source;
controlling circuitry for controlling the operation of said light source; and
a battery housing for containing said battery and said controlling circuitry, said battery housing being attached to said flat board.

10. The illuminated clip-board, according to claim 9, wherein said planar light source is bonded to said upper surface of said flat board.

11. The illuminated clip-board, according to claim 9, wherein said planar light source is coated with a transparent protective layer of plastic.

12. The illuminated clip-board, according to claim 11, wherein said protective layer includes an exposed surface that is suitable for supporting ink from a writing implement.

13. The illuminated clip-board, according to claim 9, wherein said board is made from a transparent plastic material.
